(19) United States
(12) Patent Application Publication
(10) Pub. No.: US 2008/0194355 A1
(43) Pub. Date: Aug. 14, 2008

(54) Composite Golf Club Head and Fabrication Method Thereof

(76) Inventor: Cheng-Kung Liu, Kao-Hsiung Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/017,238

(22) Filed: Jan. 21, 2008

(30) Foreign Application Priority Data
Feb. 12, 2007 (TW) 096202613

(51) Int. Cl. A63B 53/04; B23P 11/00

(52) U.S. Cl. 473/342; 473/350; 473/345; 29/525.14

(57) ABSTRACT

The present invention provides a composite club head and a fabrication method thereof. The fabrication method for a composite golf club head includes steps of: preparing a head shell part having an opened front, a flange around the opened front, and a trench on the flange, and a front plate part made of a first material containing a metal and having a protrusion; connecting the head shell part with the front plate part by engaging the trench and the protrusion; drilling a hole passing through the flange and the front plate part; screwing the head shell part and the front plate part through the hole by a second material containing the metal; and welding the first and the second materials.

### FIELD OF THE INVENTION

The present invention relates generally to an improved composite golf club head and a fabrication method thereof. More particularly, the present invention relates to a composite metal golf club head and a fabrication method thereof.

### BACKGROUND OF THE INVENTION

The complexities of golf club design are well known. The specifications for each component of the club (i,e., the club head, shaft, hosel, grip, and sub-components thereof) directly impact the performance of the club. Thus, by varying the design specifications, a golf club can be tailored to have specific performance characteristics.

The design of club heads has long been studied. Among the more prominent considerations in club head design are loft, lie, face angle, horizontal face bulge, vertical face roll, face progression, face size, sole curvature, center of gravity, material selection, and overall head weight. While this basic set of criteria is generally the focus of golf club engineering, several other design aspects must also be addressed. It is found that the club head are generally made of steel materials or ferrous materials for the fabrication conditions and the different purpose thereof. Hence, the overall head weight, the shock absorbance, or the coefficient of rebound of such club head are not ideal.

Along with the development of metallurgy, presently titanium and alloy thereof are provided for various fields. Products made of titanium or alloy thereof are famous for the corrosions resistance, the light weight and the highly rigidity thereof. Hence, some manufactories combine titanium-containing face with the head body to from a composite club head.

Presently, means for combining of the titanium containing face and the head body is welding technology. However, welding these two components (the titanium containing face and the head body being made of steel or ferrous materials) with their physical properties being quite different, such as the melting points thereof, the heat conductivities thereof, the thermal expansion coefficient thereof, and etc. needs more pretreatment processes, such as electroplating and chemical deposition, or it must be carried out by special welding technology, for example, the explosive welding. In addition, club heads fabricated by such methods are not only easily disengaging the face from the main body, but also the transmitting of the hitting force thereof is affected, which changes the inertia trajectory thereof and reduce the stability thereof. Hence, the presently used methods, as mentioned above, are either complicate or difficult and the club head fabricated thereby are not ideal.

Thus, the club face and body should be designed to resist the repeated impacts that occur during collisions between the golf club and the golf ball Therefore, there is a need to develop a composite club head and a fabrication method thereof that can overcome the above drawbacks.

### SUMMARY OF THE INVENTION

According to the above drawbacks, an objective of the present invention is to provide a lighter, simpler, stronger and more stable composite club head and a fabrication method thereof.

Another objective of the present invention is to provide a composite club head and a fabrication method thereof, wherein the composite club head has a bigger sweet spot area, preferably, to an extent that equals to the hitting front.

Still another objective of the present invention is to provide a composite club head with better reliance, better buffering (hit absorption), and greater carry distance and a fabrication method thereof.

In order to attain the above and other objectives, the present invention discloses a composite golf club head, comprising: an open-front hollow main body part, a front plate part and a welding element, wherein the open-front hollow main body part has a trench and a first hole passing through the trench, the front plate part is made of a first material containing a metal and has a protrusion and a second hole, which is deposed on the protrusion and passing through the front plate part, the second hole is corresponding to the first hole, the front plate part is attached to the front of the main body part by an engaging of the protrusion and the trench, the a welding element is made of a second material containing the metal and secures the engaging by passing through the holes and welding with the front plate part.

Preferably, the trench is deposed at a periphery of the front.

Preferably, the front plate part is a cup-shaped plate.

Preferably, the protrusion is deposed at a periphery of the front plate part.

Preferably, the holes are screw holes, the welding element is a screw, and the front plate part and the main body part are screwed by the holes and the welding element before the welding.

Preferably, the main body part is made of one of a steel material and a ferrous material.

Preferably, the main body is one of an iron club head and a wood club.

Preferably, the metal is one of a titanium and a maraging steel.

In order to attain the above and other objectives, the present invention also discloses a fabrication method for a composite golf club head, comprising steps of: preparing a head shell part having an opened front, a flange around the opened front, and a trench on the flange, and a front plate part made of a first material containing a metal and having a protrusion; connecting the head shell part with the front plate part by engaging the trench and the protrusion; drilling a hole passing through the flange and the front plate part; screwing the head shell part and the front plate part through the hole by a second material containing the metal; and welding the first and the second materials.

Preferably, the fabrication method further comprises a step of: milling the front plate part and the second material containing the metal to from an even hitting surface of the front plate part after the welding.

Preferably, the head shell part provided is one of an iron club head and a wood club.

Preferably, the head shell part and the front plate part are made of materials containing different metals.

Preferably, the metal is titanium, and the head shell part is made of one of a steel material and a ferrous material.

Preferably, the trench and protrusion are prepared by a CNC method.

Preferably, the front plate part is cup-shaped.

As the melting element for securing the engaging of the protrusion and the trench contains the same metal as that of the front plate part, the composite club head obtained through the present invention becomes much integral, thus the sweet spot area is enlarged to an extent that equals to the front plate part, and the product reliability is increased and the fabrication cost is decreased. Meanwhile, as a trench and a protrusion provided on the main body part and the front plate part, the process is simplified and the time and costs are reduced. In addition, the simplified fabrication method of the present invention increases the fabrication efficiency and yield. As the front plate part is made of a lighter material in comparison with that of the main body part, center of gravity of the composite club head is able to be shift to the main body part, which increase the stability of the composite club head, and is more friendly for users.

### BRIEF DESCRIPTION OF THE DRAWINGS

The present invention can be more fully understood by reading the following detailed description of the preferred embodiments, with reference made to the accompanying drawings, wherein:

FIGS. 1 to 3 are schematic diagrams showing a fabrication method of a composite club head according to a first embodiment of the present invention; and

FIG. 4 is a schematic diagram showing a composite club head according to a second embodiment of the present invention;

### DETAILED DESCRIPTION OF THE PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

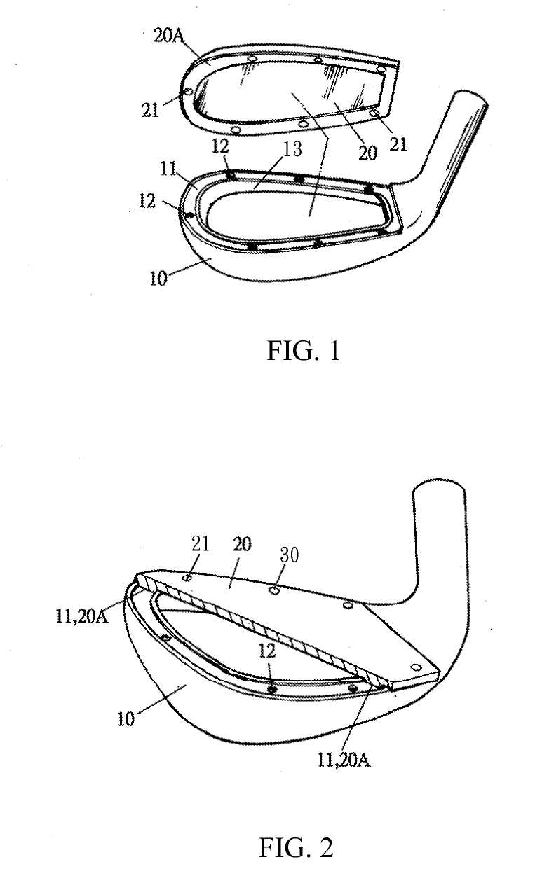

Please refer to FIGS. 1 and 2, which are schematic diagrams showing a fabrication method of a composite club head according to a first embodiment of the present invention. As show in the diagrams, a main body part 10 of an iron club head is provided, wherein the main body part 10 is an open-front hollow main body part having a flange 13 around the open-front, and is milled by CNC method to have a trench 11 on the flange 13. A front plate part 20 made of a first titanium containing material and having a protrusion 20A is provided, wherein the protrusion 20A is prepared by milling on the periphery of the front plate part 20 by CNC method to allow the protrusion 20A of the front plate part 20 to be able to engage with the trench 11 of the main body part 10.

Then, engaging the front plate part 20 and the main body part 10 by engaging the trench 11 and the protrusion 20A as in FIG. 2. The front plate part 20 and the main body part 10 are drilled with screw holes 21 and 12 simultaneous after the engaging of the trench 11 and the protrusion 20A, where the holes 21 are disposed on the protrusion 20A and are passing through the front plate part 20, and the screw holes 12 are disposed on the trench 11 and passing through the flange 13. Alternatively, drilling of screw holes 21 and 12 can be carried independently, where the screw holes 21 are corresponding to the screw holes 12.

After drilling, screwing the main body part 10 and the front plate part 20 through the holes 12 and 21 by a welding element 30 made of a second titanium containing material. Then welding titanium-containing materials, i.e. the welding element 30 and the front plate part 20.

Then, as shown in FIG. 3, the welded front plate part 20 and the welding element 30 are milled from an even hitting surface 31 with strips 32 of the front plate part 20, thus the composite club head is formed.

Alternatively, the front plate 20 can be made of a maraging steel containing material and the accordingly welding element 30 used is made of the same of different materials as long as it also contains maraging steel.

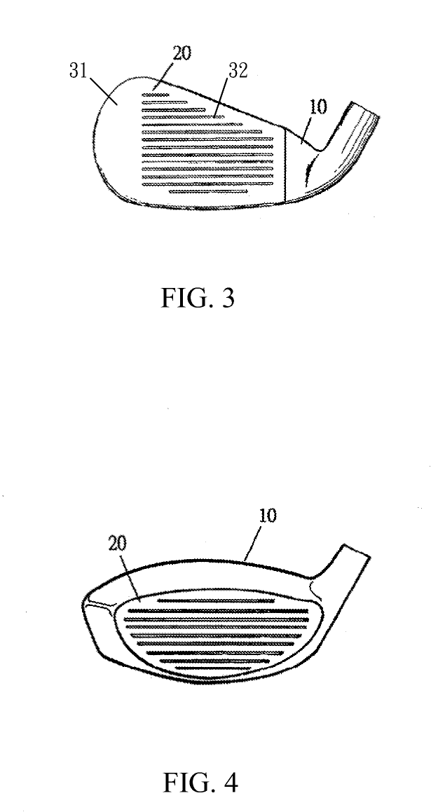

Please refer to FIG. 4, which is a schematic diagram showing a composite club head according to a second embodiment of the present invention. The main difference of the present embodiment from the first embodiment is that the main body part of the first embodiment is an iron club head and a main body part 20 of the present embodiment is a wood club head

As the melting element for securing the engaging of the protrusion and the trench contains the same metal as that of the front plate part, the composite club head obtained through the present invention becomes much integral, thus the sweet spot area is enlarged to an extent that equals to the front plate part, and the product reliability is increased and the fabrication cost is decreased. Meanwhile, as a trench and a protrusion provided on the main body part and the front plate part, the process is simplified and the time and costs are reduced. In addition, the simplified fabrication method of the present invention increases the fabrication efficiency and yield. As the front plate part is made of a lighter material in comparison with that of the main body part, center of gravity of the composite club head is able to be shift towards the main body part, which increases the stability of the composite club head, and is more friendly for users. As weight of the front plate is reduced by the use of the titanium containing material, size of the main body part could be increased, thereby increasing the sweet spot area.

What is claimed is:

1. A composite golf club head, comprising:
an open-front hollow main body part having a trench and a first hole passing through the trench; and
a front plate part made of a first material containing a metal and having a protrusion and a second hole deposed on the protrusion and passing through the front plate part, wherein the second hole is corresponding to the first hole, and the front plate part is attached to the front of the main body part by an engaging of the protrusion and the trench; and
a welding element made of a second material containing the metal and securing the engaging by passing through the holes and welding with the front plate part.

2. The golf club head of claim 1, wherein the trench is deposed at a periphery of the front.

3. The golf club head of claim 1, wherein the front plate part is a cup-shaped plate.

4. The golf club head of claim 1, wherein the protrusion is deposed at a periphery of the front plate part.

5. The golf club head of claim 1, wherein the holes are screw holes, the welding element is a screw, and the front plate part and the main body part are screwed by the holes and the welding element before the welding.

6. The golf club head of claim 1, wherein the main body part is made of one of a steel material and a ferrous material.

7. The golf club head of claim 1, wherein the main body is one of an iron club head and a wood club.

8. The golf club head of claim 1, wherein the metal is one of a titanium and a maraging steel.

9. A fabrication method for a composite golf club head, comprising:
preparing a head shell part having an opened front, a flange around the opened front, and a trench on the flange, and a front plate part made of a first material containing a metal and having a protrusion;
connecting the head shell part with the front plate part by engaging the trench and the protrusion;
drilling a hole passing through the flange and the front plate part;
screwing the head shell part and the front plate part through the hole by a second material containing the metal; and
welding the first and the second materials.

10. The fabrication method claim 9, further comprising a step of:
milling the front plate part and the second material containing the metal to from an even hitting surface of the front plate part after the welding.

11. The fabrication method claim 9, wherein the head shell part provided is one of an iron club head and a wood club.

12. The fabrication method claim 9, wherein the head shell part and the front plate part are made of materials containing different metals.

13. The fabrication method claim 9, wherein the metal is titanium, and the head shell part is made of one of a steel material and a ferrous material.

14. The fabrication method claim 9, wherein the trench and protrusion are prepared by a CNC method.

15. The fabrication method claim 9, wherein the front plate part is cup-shaped.
